(19) United States
(12) Patent Application Publication
(10) Pub. No.: US 2005/0005453 A1
(43) Pub. Date: Jan. 13, 2005

(54) Water pressure driven wet and dry shaver with beard trimmer, water clean out, and speed control

(76) Inventor: Zoltan Egeresi, Santa Cruz, CA (US)

Correspondence Address: ZOLTAN EGERESI, 5500 COAST RD., SANTA CRUZ, CA, 95060, US

(21) Appl. No.: 10/614,270

(22) Filed: Jul. 7, 2003

(51) Int. Cl. B26B 19/00

(52) U.S. Cl. 30/34.1

(57) ABSTRACT

This invention has a unique, new way to drive the “electric” type shavers, miniature water turbine. The water pressure driven shaver uses the water from the faucet as a “parasite”, free power source from the bathroom or the shower outlet with a diverter to rotate the turbine, water remains recyclable. It uses no electricity, cost effective, it is waterproof, submergible. The water valve by controlling the flow becomes Speed Control of the Water Pressure Driven Wet and Dry shaver. It is adaptable to most prior art circular rotating and flat vibrating type shaver with or without beard trimming. After shaving, as a new invention, built in water jet flushes out hair particles at flushing outlets, Flush-out Cleaning. Shaver has a holding ring to hang it up by the sink or by the shower. Vertical, worm gear type turbine driven shaft is used in nose hair trimmer version of this invention, with clean out water nozzle. Version of this invention is a water pressure driven massaging apparatus.

### BACKGROUND OF THE INVENTION

Shavers come mainly in two categories. Wet, manual shaver with blades using some kind of a shaving cream or electric shavers. Electric shavers have either a round shaving head where the cutting blade is rotated, straight or angled or the flat, oscillating, vibrating type.

The electric razors all use electricity, AC or DC with rechargeable batteries with limited charge/discharge cycle and some uses alkaline throw away batteries,

Life span of most shaver is reduced due to water incursion to the electric area, motor gets damp or wet, or rechargeable batteries are not easily replaceable and it gets disposed.

Cleaning hair particles out of the razor screen area need brushing, air blowing and in some newer shavers the motor has a better insulation from water, allowing water cleaning of detachable shaver head.

Shavers are not truly wet and dry types, they are wet or dry.

My new invention has a solution for these type of short comings.

This Water Pressure Driven Wet and Dry Shaver with Beard Trimmer, Water Clean out, and Speed Control is a true wet and dry shaver.

My new invention has no electric parts, 100% waterproof, it is submergible, it uses no electricity.

It uses free parasite power source (water pressure), no batteries need to be recharged or exchanged.

This new Water Pressure Driven Wet and Dry Shaver with Beard Trimmer, Water Clean out, and Speed Control is a true 100% wet or dry shaver.

Built in water nozzle flushes our hair particles solving prior arts' water intrusion problems into the motor, driving area.

### DESCRIPTION OF PRIOR ART

U.S. Pat. No. 4,549,352 Ochiai, et al. Oct. 29, 1985 Washable electric shaver.

A washable electric shaver comprising a water-tight housing having a drive motor therein and a switch. This invention is directed to a dry shaving apparatus with a housing in which an electric drive mechanism U.S. Pat. No. 5,299,354 Metcalf, et al. Apr. 5, 1994 Ocillating shaver

An oscillating wet shave razor with a battery powered motor rotating an eccentric element within the head portion of the razor handle to generate an oscillating vibration to the razor blade cartridge.

U.S. Pat. No. 5,544,415 Huang Aug. 13, 1996 Water-proof and washable electric razor.

A structure of an electric water-proof detachable and washable razor has a unit of detaching blades and a unit of water-proof shells for receiving a battery, a motor, a switch.

U.S. Pat. No. 5,649,556 Braun Jul. 22, 1997 Cleaning device for cleaning the shaving head of a dry shaving apparatus. The invention is directed to a cleaning device for cleaning the shaving head of a dry shaving apparatus with a cradle structure adapted to receive the shaving head, a cleaning fluid container holding a cleaning fluid, as well as a device adapted to be driven by a motor for feeding the cleaning fluid.

U.S. Pat. No. 5,933,962 by Labarbara Aug. 10, 1999 Oscillating razor is a detachable oscillating unit is provided which converts a conventional wet shave razor, such as a disposable razor, into an oscillating wet shave razor. U.S. Pat. No. 6,497,043 by Jacobsen Dec. 24, 2002 Intelligent shaver, a shaving device with one or more shaving blades. Sensors are attached to (or near) the blades which produce a shaving signal. A processor or intelligent analysis unit then receives the shaving signal and determines what shaving changes should be made.

U.S. Pat. No. 6,493,941 Wong Dec. 17, 2002 Motor-driven razor uses a foil-type electric razor includes with a coaxial motor and cutter.

U.S. Pat. No. 6,357,118 Eichhorn, et al. Mar. 19, 2002 Electric razor.

Current U.S. Class: 134/92; 134/111; 134/166R; 134/186,

Field of Search: 134/111, 155, 186, 92, 184, 166 C, 166 R, 201, 62, 116, 135, 30/45, 44, 210, 537, DIG. 1

### REFERENCES CITED [REFERENCED BY]: 30/45; 30/44

U.S. Patent Documents

U.S. Pat. No. 4,549,352 Ochiai, et al. Oct. 29, 1985
U.S. Pat. No. 4,819,330 April, 1989 Fenn et al.
U.S. Pat. No. 5,007,169 April, 1991 Motta.
U.S. Pat. No. 5,046,249 September, 1991 Kawara et al. 30/45.
U.S. Pat. No. 5,214,851 June, 1993 Althaus.
U.S. Pat. No. 5,299,354 Metcalf, et al. Apr. 5, 1994
U.S. Pat. No. 5,544,415 Huang Aug. 13, 1996
U.S. Pat. No. 5,649,556 Braun Jul. 22, 1997
U.S. Pat. No. 5,933,962 by Labarbara Aug. 10, 1999
U.S. Pat. No. 6,357,118 Eichhom, et al. Mar. 19, 2002
U.S. Pat. No. 6,497,043 by Jacobsen Dec. 24, 2002
U.S. Pat. No. 6,493,941 Wong Dec. 17, 2002
Intern'l Class: B08B 009/00, B26B 021/38
   Foreign Patent Documents
911412 July, 1946 FR 30/45.
1 841 789 November, 1961 DE.
1 406 830 November, 1972 GB.
36 10 736 October, 1987 DE.
41 28 218 August, 1992 DE.
43 03 972 October, 1993 DE.
2 318 722 May, 1998 GB.

### SUMMARY OF THE INVENTION

This invention has a unique, new way to drive the “electric” type shavers, miniature water turbine. The water pressure driven shaver uses the water from the faucet in the bathroom or the shower outlet with a diverter to rotate the turbine, remains clean and reusable. This shaving device uses no electricity, environmental friendly, uses no alkaline or rechargeable batteries, only water in the home or in a hotel's water system. Water volume adjustment is the shaver's speed control, allows the user to adjust the shaver's speed.

The Water Pressure Driven Wet and Dry Shaver with Beard Trimmer, Water Clean out, and Speed Control is a new way to power up the “electric shavers”, most prior art types are adaptable. It saves money, water pressure in the city water system is used as a free “parasite” power source. This invention solves the long cleaning problem by allowing a built in water jet to rinse out the shaver from inside without destroying any component. It is waterproof, it is submergible.

Vertical, worm gear type turbine driven shaft is used in nose hair trimmer version of this invention, with clean out water nozzle and a version of the apparatus is water pressure driven massager invention. In respect, before explaining at least one embodiment of the invention in detail, it is to be understood that the invention is not limited in its application to the details of construction and to the arrangements of the components set forth in the following description or as it is illustrated in the drawings.

### OBJECTS OF THE INVENTION

The main object of the invention is to create a new line of shavers by designing a water proof

Wet and Dry shaver with an easy clean out which is adaptable to most prior art rotating or oscillating electric shavers with or without beard trimmer and nose hair trimmer. Provide a new economical way to drive the “electric” type shavers by replacing electricity as the energy source with water pressure.

By using a small water turbine which is adaptable to most electric razors, this Water Pressure Driven Wet and Dry Shaver is a 100% water proof, it is submergible.

The other object is to provide a clean out for the shaver by using a built in water jet, since there are no electric parts in the invention, no parts can be damaged in the apparatus by water.

By pressing the built in nozzle valve, the water flushes out all hair particles.

The water valve acts as a Speed Control by controlling the water flow, the user can adjust for the most desirable shaver speed.

### BRIEF DESCRIPTIONS OF THE INVENTION

This invention has a unique, new way to drive the “electric” type shavers, miniature water turbine.

The water pressure driven shaver uses the water from the faucet in the bathroom or the shower outlet with a diverter to rotate the turbine.

The Water Pressure Driven Wet and Dry Shaver with Beard Trimmer, Water Clean-out and Seed control is a new way to shave, economical, waterproof, it has a water clean out built in nozzle flushing away hair cuttings.

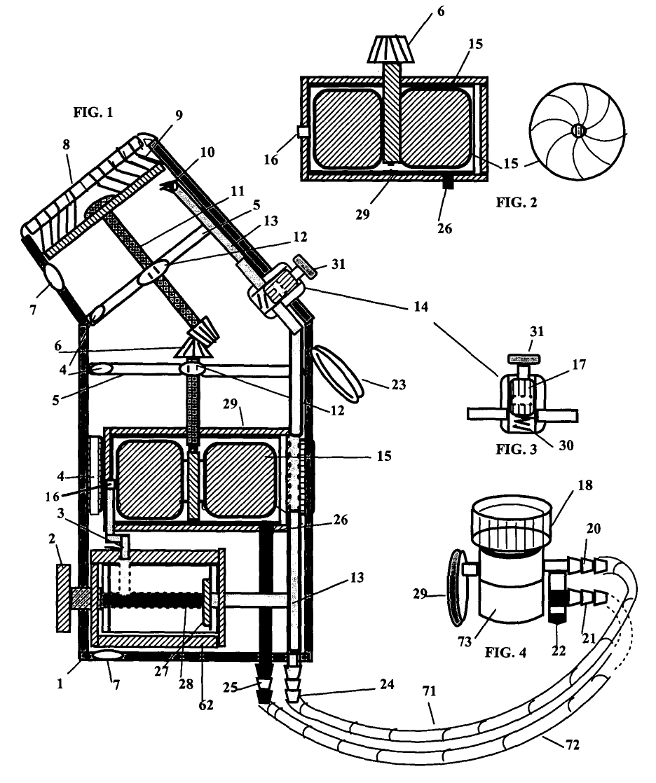

On page 1 of the drawing FIG. 1 shows a shaver with an angled rotating blade assembly.

Water comes from the faucet from the diverter on FIG. 4. switch (62) controls the water flow and turbine (29) speed, and this rotation drives the round shaver blade (9). Normally closed push button valve (14) when activated the water flushes out the hair particles with nozzle (10), derbies flow out at opening (7) and opening (4). Hook (23) provides convenient hanging option if shaver is not in use.

Page 7 FIG. 13 shows a straight version of the water pressure driven circular shaver with beard cutter, speed control and clean out system like on page 2.

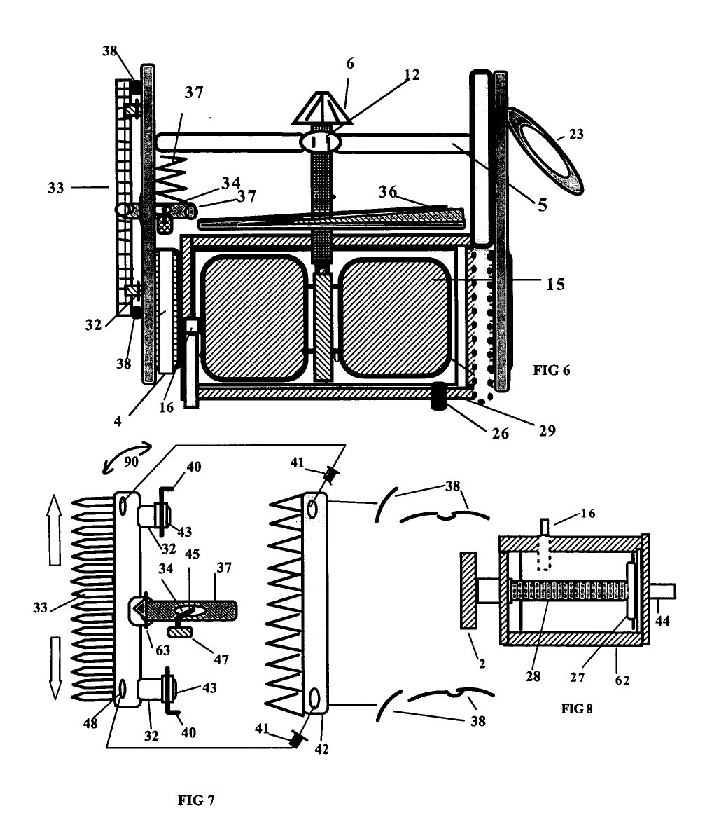

FIG. 5 page 2 shows the same turbine (29) driven shaver with beard trimmer (33). Turbine rotates the the slanted rotating driving disk (36), moves cam follower (37) up and down which oscillates the moving cutting blade (33). When beard trimming is desired, blades are rotated outward 90 degree, stationary blade (42) is locked into the cutting position by leaf springs (38).

Page 4 FIG. 10 shows nose hair trimmer with a vertical worm gear type turbine (57).

FIG. 11 diverter provides the water under pressure at barbed connector (20) to the nose hair trimmer (61 to the on off switch valve (62), in A position it rotates the turbine blades (57) which drives the shaft (52) with blades (49). Valve (71) in and B position squirts water into the hair cutting area to flush out all hair.

Page 5 FIG. 12 shows a flat oscillating water turbine driven shaver.

Blades (15) of the driving turbine (6) is activated by the water as it flows in at barbed connector (24), flows trough speed control valve (71) when valve is opened by knob (2).

### BRIEF DESCRIPTIONS OF THE INVENTION

Page 5 FIG. 12 Turbine (6) drives cam (64) as it rotates shaver arm (69) and oscillates the curved, flat shaving blade (18) as it moves under the screen (65). Speed control on/off valve (71) controls the flow of water, push button type nozzle control (14) is to rinse out all the hair derbies.

When shaving is finished, clean out nozzle switch (14) is depressed, letting the water flow trough to flush out the hair particles, dirty water exits at opening (7).

Page 6 FIG. 13 shows the same flat-water turbine driven shaver with side beard trimmer (33, 34).

Spring (63) keeps beard trimmer arm (46) following cam (64) as it rotates and is pivoted at (47) and moves beard cutter blade (33) up and down.

Since no electricity or electrical driving motor is used, it is waterproof, shaver can be used dry or wet even while taking shower. Shaver has a holding ring (23) to hang it up by the sink or by the shower.

This simplified construction also reduces manufacturing costs

Page 7 FIG. 13 is the straight circular shaver version of the angled FIG. 5 one as it is explained earlier on The water pressure driven circular straight wet and dry shaver (15) with side beard trimmer (33,34) in open position, with clean out nozzle (10), driving turbine (29), speed control valve (62) turbine shaft (11). This drawing shows a common “electric” shaver type embodiment, but this design is completely non electrical, water proof, water resistant, submergible, has speed control, and water flushing clean out. Since no electricity or electrical driving motor is used, it is waterproof, shaver can be used dry or wet even while taking shower. Shaver has a holding ring (23) to hang it up by the sink or by the shower.

Page 8 FIG. 15 shows Water pressure Driven Massager (78) vertically positioned miniature water turbine (57) with valve/speed control (62) water injector valve (14) and detachable, replaceable vibrator/massager head (75). In respect, before explaining at least one embodiment of the invention in detail, it is to be understood that the invention is not limited in its application to the details of construction and to the arrangements of the components set forth in the following description or as it is illustrated in the drawings.

### DETAILED DESCRIPTION OF THE INVENTION

This invention has a unique, new way to drive the “electric” type shavers, as many prior art types are available and adaptable to be used with this invention.

The new shaver power source is a miniature water turbine which drives the shaver, beard or nose hair trimmer. The water pressure driven shaver uses the water as a “parasite” power source from the faucet in the bathroom or in the shower outlet or even in hotel rooms.

The Water Pressure Driven Wet and Dry Shaver with Beard Trimmer, Water Clean-out and Speed control is a new way to shave, economical, waterproof, it has a water clean out built in nozzle flushing away hair cuttings.

On page 1 of the drawing FIG. 1 shows a shaver with an angled rotating blade assembly.

Water comes from the faucet from the diverter on FIG. 4. Diverter (73) is attached to the faucet by the treaded connector (18). When faucet is turned on diverter's knob (29) turns on the water pressure and water exits at barbed connector (20). The primary water volume controller is the diverter, by partial diverter opening the reduced water volume creates a slower turbine FIG. 2 (29) rotation therefore reducing the shaver's speed.

Water under pressure flows to the shaver trough the dual flexible hose (71) connects to barbed connector (24), pipe (13) and enters into the shaver's water volume controller valve (62) on FIG. 1 and becomes a speed control for the shaver. When speed control volume's knob (2) is opened, washer (27) lets the water flows up to the turbine (29) trough pipe (3) and enters at connector (16). Water under pressure rotates the turbine's blades (15), than used, clean water exits at outlet (26), barbed connector (25), outflow hose (72) to diverter (73) barbed outflow connector (21), out to sink at (22), reusable clean water.

When the turbine (29) is rotating shaft (11) with gears (6) transfer the rotational force to spin the circular blades (9). Rotating shaft is held in place by spacers (5), shaft guide or bearings (11), gear ratio of coupling gears (6) selects predetermined shaver speed.

### DETAILED DESCRIPTION OF THE INVENTION

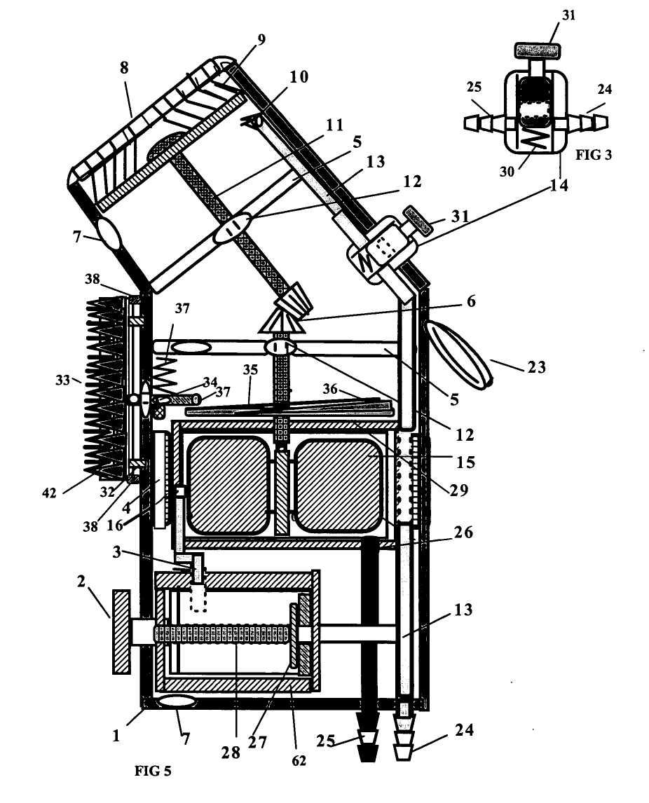

Normally closed push button valve on FIG. 3 (14) is closed by spring (30), when activated by depressing button (31) valve cylinder (17) moves down to let the water flow up in pipe (13) to nozzle (10) than water flushes out the hair particles with nozzle (10), derbies flow out at top opening (7) or if shaver is hanging on it's hook (23) any excessive water can drip out at the bottom opening (7). Inter chamber opening (4) let any water left in chambers to drip out.

Page 2 FIG. 5 and Page 3 FIG. 6, and 7 show the same Water Pressure Driven Wet and Dry Shaver with Beard Trimmer, Water Clean-out and Speed control with beard trimmer (33) in active position. Turbine rotates the slanted rotating driving disk (36), it moves cam follower (37) up and down which oscillates the moving cutting blade (33). Cutting blades oscillating (33) and stationary (42) are tightly connected together (but movable) by rivets (41). When beard trimming is desired, blades are rotated outward 90 degree, stationary blade (42) which is locked into the cutting position by the leaf springs (38) which is indented in the middle and attached to the body of the shaver (1), it is 90 degree offset compared to the beard cutting stationary blade (42), than gets locked into the cutting position by leaf springs (38). Stationary blade (42) is closer to the body (1) of the shaver and in open position leaf spring (38) holds it in position while rivets (41) are loose enough to allow oscillating motion of blade (33). Blade (33) is attached to the body (1) by pins (40) loosely fitting in metal tube (43) on hinge (32) to allow up and down motion. When beard trimmer is not in action, as shown on FIG. 6, cam follower (37) is moved away from the rotating cam (36), in active position by pivoting the cutter assembly as shown on FIG. 5 cam follower (37) is moved above the slanted cam surface (36) and pushed down by spring (37). Cam follower is pivoted by pin (34) which is attached to the body at location (47). Elongated slot (34) in cam follower (37) allows the extra horizontal motion when beard trimmer moves from closed to open position. Cam follower is attached to the movable trimmer (33) by pin (63).

### DETAILED DESCRIPTION OF THE INVENTION

Page 4 FIG. 10 shows a Water Pressure Driven Wet and Dry Nose Hair Trimmer with Water Clean-out and with Speed control.

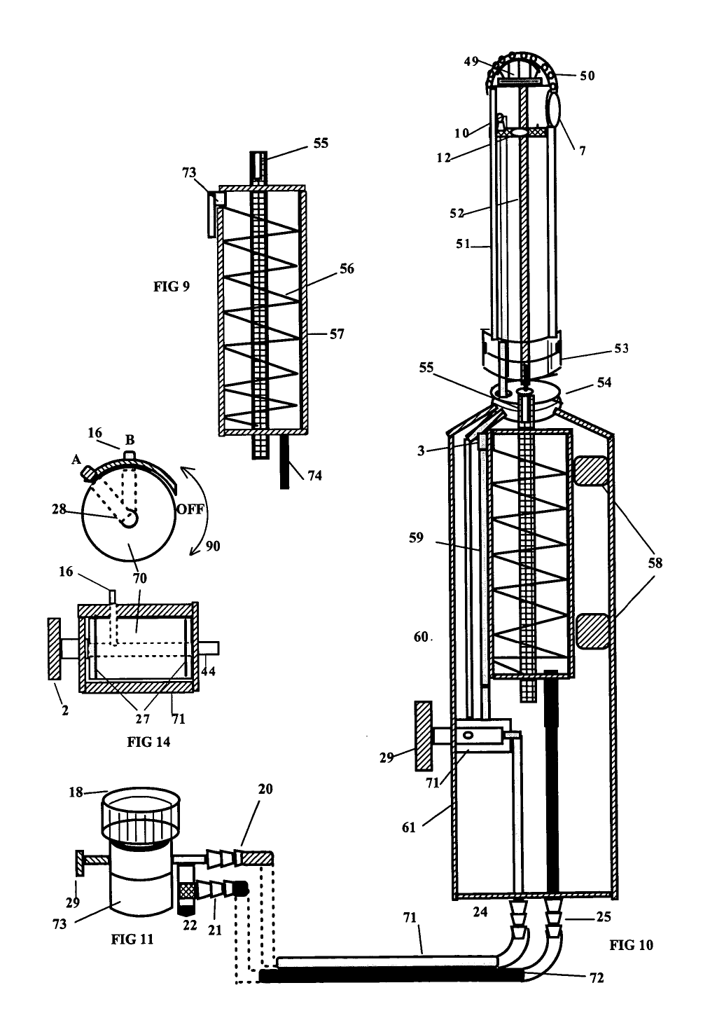

This version of the Water turbine driven shaving apparatus (61) is a vertical, worm gear type (57) as shown on the drawing on FIGS. 9 and 10 in a different embodiment of the invention (electric tooth brush type). Diverter (73) supplies the water pressure as it comes in at barbed connector (20), dual hose supply side (71) nose hair trimmer with a vertical worm gear type turbine (57).

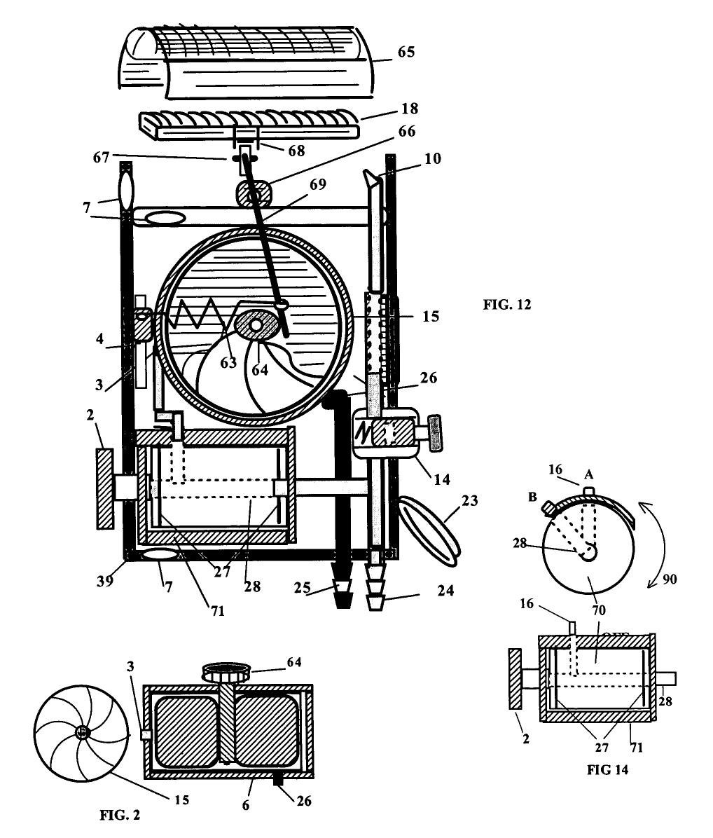

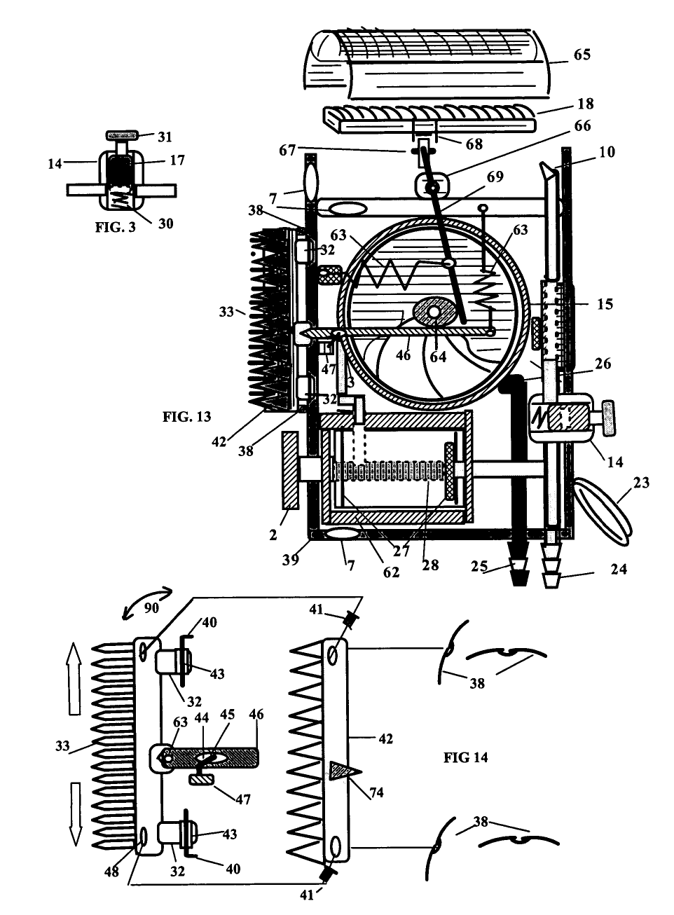

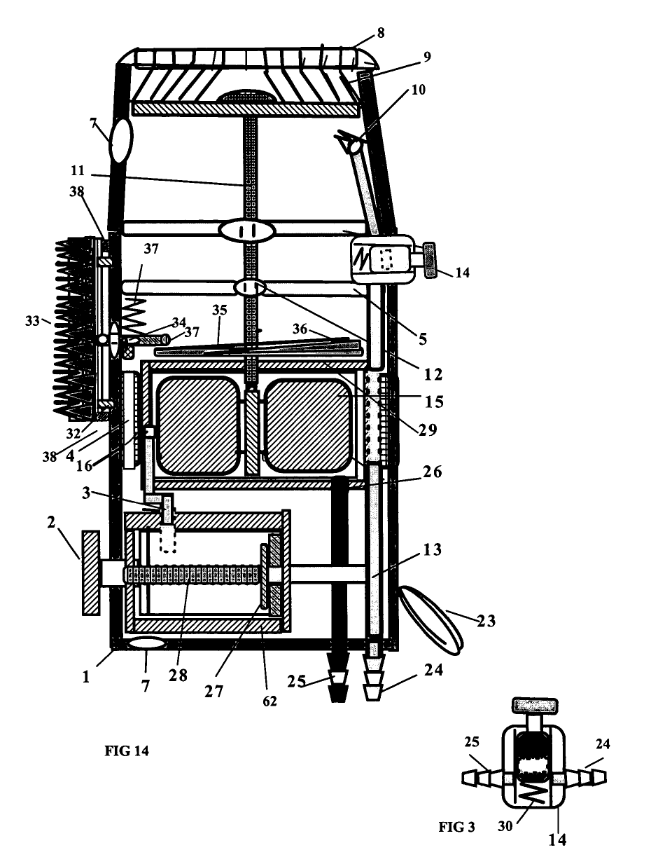

Water enters at barbed connector (24) into the water valve (62) which has three positions, OFF, A, and B. Water valve on FIG. 14 has a rotating inner cylinder with a hole in the center for the water to enter at inlet (28) than water leaves trough an angled outlet A or B.

When Knob (29) is on in A position, it allows the water to flow in tube (59) than at connector (73) into vertical turbine (57) and rotates the worm gear type blade (56), than the de-energized water leaves at connector (74), barbed connector (25), return water line (72), barbed connector (21) and out at (22). Turbine (57) is supported at two location by anchoring posts (58). When the turbine is rotating shaft (55) drives the nose hair cutter driving shaft (52) in the detachable nose hair cutting assembly (51). Rotating shaft (52) is supported by spacer (12) and on the top it rotates an inverted U shaped blade (adaptable to prior art electric nose hair cutter blade assembly).

Valve (62) in and B position squirts water into the hair cutting area as it flows up on tube (60) and exist at nozzle (10) to flush out all hair. Flushing water leaves at opening (7). This water pressure driven nose hair cutter is totally waterproof, submersible with a built in flush away system.

### DETAILED DESCRIPTION OF THE INVENTION

Page 5 FIG. 12 shows a flat oscillating Water Pressure Driven Wet and Dry Shaver with Beard Trimmer, Water Clean out, and Speed Control (39).

Water under pressure enters from the diverter (73) FIG. 11 at barbed connector (24) and enters in valve (71) A/B/OFF which provides more of a fixed speed, by rotating valve (28) on FIG. 5 page 14, provides a narrower range of speed control as it allows completely or partially open the valve at A or B.

On FIG. 12 when the water valve (2) is open, turbine (6) blades (15) start rotating with and attached oval cam (64), oscillates cam follower (69) which held close to the cam by spring (63).

Speed control valve (71) when valve is opened by knob (2) turbine (15) drives cam (64), it moves shaver arm (69) and vibrates cutting blade assembly (18).

Spring (63) keeps tension on the shaver arm. Oscillating shaving arm (69) is pivoted at pivoting post (66) attached at the top by pin (67), fitting into the lower part of oscillating shaver blade assembly (18) against fixed position shaving screen (65) for cutting facial hair.

When shaving is finished, clean out nozzle switch (14) is depressed, letting the water flow trough to flush out the hair particles with nozzle (10), dirty water with hair cuttings flow out at opening (7).

Page 6 FIG. 13 shows the same flat water turbine driven shaver with side beard trimmer (33, 34).

Spring (63) keeps beard trimmer arm (46) following cam (64) as it rotates and is pivoted at (47) and moves beard cutter blade (33) up and down.

When beard trimming is desired as shown on FIG. 13. blades are rotated outward 90 degree, stationary blades (42) is locked into the cutting position by the leaf springs (38) which is indented in the middle. Vibrating blade (33) is loosely attached to the body of the shaver (39) with hinges (32) which slides up and down around the pin (40) in the metal guiding tube (43).

The edge of the stationary blade (42) sits in the indented leaf spring (38) during trimming.

### DETAILED DESCRIPTION OF THE INVENTION

Stationary blade (42) is closer to the body (1) of the shaver and in open position leaf spring (38) holds it in position while rivets (41) are loose enough to allow oscillating motion of blade (33).

Blade (42) is attached to the body (39) by hinges (32) with pins (40) loosely fitting in metal tube (43) to allow up and down motion.

When beard trimmer is not in action, beard cutting assembly (33, 42) is folded flat against the body (39) of the shaver. Just below the tip of the cam follower (46) attached to blade (42) is the sloped cam lifter (74).

Cam lifter (74) in closed position lifts up the end of the cam follower (64) just enough, to disengage it from the driving cam (64).

Page 7 FIG. 13 is the straight circular shaver version of the angled one as it is explained earlier on page 11 FIG. 5. On page 7 of the drawings is the water pressure driven circular straight wet and dry shaver (15) with side beard trimmer (33,34) in open position, with clean out nozzle (10), driving turbine (29), speed control valve (62) turbine shaft (11)

This drawing shows a common “electric” shaver type embodiment, but this design is completely non electrical, water proof, water resistant, submergible, has speed control, and water flushing clean out.

Since no electricity or electrical driving motor is used, it is waterproof, shaver can be used dry or wet even while taking shower. Shaver has a holding ring (23) to hang it up by the sink or by the shower.

### DETAILED DESCRIPTION OF THE INVENTION

Page 8 FIG. 15 shows the Water Pressure Driven Massager (78) with vertically positioned miniature water turbine (57) with valve/speed control (62) water injector valve (14) and detachable, replaceable vibrator/massager head (75). Water under pressure comes from diverter (73), out on barbed connector (20), flexible hose (71) usually a ¼ inch connects to input barbed connector (24) of massager (78).

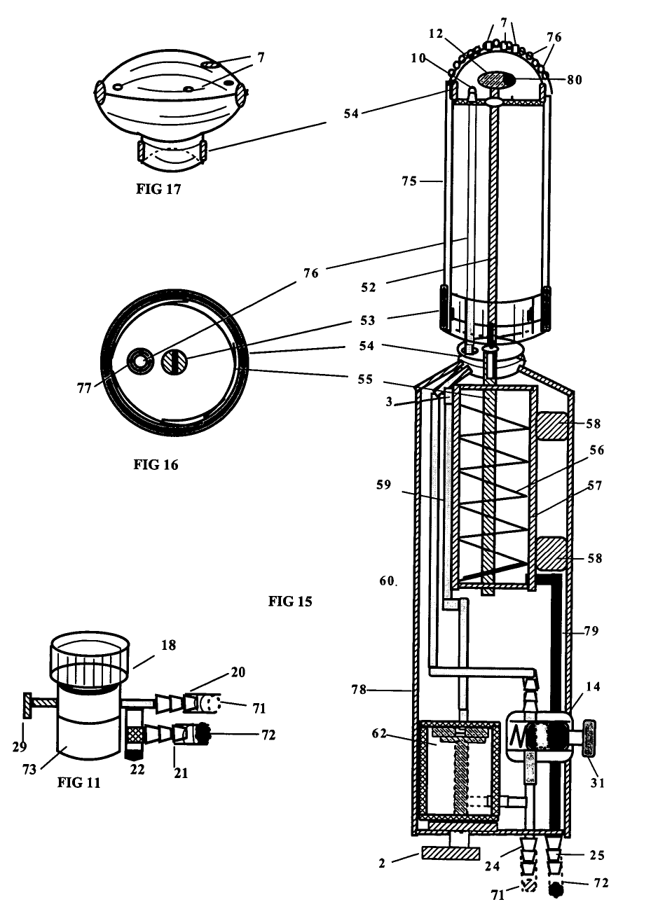

Water enters into the valve (62), by turning valve knob (2) to the open position it allows water to flow to the turbine (57) at connection (3) to rotate vertical turbine blade (56) than water exist in tube (79), barbed connector (25), return line (72), connector (1) than to sink outlet (22). Diverter can also be connected to the shower. Massager head assembly (75) is connected to the massager's main assembly (78) by threaded connection (54), than connects turbine shaft (55) to vibrator shaft (52)—supported by bearings (12)—which rotates an eccentric plate (80) to create the vibrating, massaging effect. On top of massager head (75) cover (76) is bumpy surfaced, replaceable and it has 1-5 openings (7) where water at preset temperature flows out after valve (14) is depressed by push button (31). Massager head assembly (75) when connected to the main assembly turning the threaded sleeve (53), in secured position washer (77) on FIG. 16 holds the water line together without any leak. FIG. 17 shows a different massaging head connectable by threads (54).

In respect, before explaining at least one embodiment of the invention in detail, it is to be understood that the invention is not limited in its application to the details of construction and to the arrangements of the components set forth in the following description or as it is illustrated in the drawings.

What I claim as my new invention is the Water Pressure Driven Wet and Dry Shaver with Beard Trimmer, Water Clean-out, and Speed Control where a small water turbine connecting to the household's water system via a diverter to the sink or to the shower becomes the “parasite” power source for this invention.

1. This Invention creates a new line of Water Pressure Driven Wet and Dry Shaver by using a miniature Water turbine running on household water under pressure creates the power to rotate a miniature turbine as the engine, Wet or Dry waterproof, submersible shaver.

2. This invention enables a new way to clean out hair particles, by a Water Clean-out System, where a water nozzle valve when depressed, flushes out any hair pieces trough a flush out opening. Since there are no electrical parts used at all flashing water does not create any problem.

3. This Wet and Dry Shaver driven by a small water turbine is controlled by the flow control valve therefore it becomes Speed Controlled Wet and Dry Shaver driven by a small water turbine.

4. In my invention of the Water Pressure Driven Wet and Dry Shaver with Beard Trimmer, Water Clean out and Speed Control FIG. 1 on drawing pages shows an angled rotary shaver with speed control water flush out system and mini turbine as in claim 1, 2 and 3. FIG. 7 illustrates a straight circular Water Pressure Driven Wet and Dry Shaver with Beard Trimmer, Water Clean out and Speed Control. Water under pressure enters into the water flow control valve, which in turn becomes the Speed Control through an on/off valve, rotates the turbine, than the recyclable clean water flows out to the sink via the return water line, flushed our hair is drained. Speed is controlled by the quantity of water flow for the desired, maximum valve opening provides maximum speed, partially opened valve reduces the razor's speed.
In my invention of the Water Pressure Driven Wet and Dry Shaver with Beard Trimmer, and speed control FIG. 5, FIG. 6, FIG. 7 illustrates side mounted beard trimmer. Beard trimmer is driven by the slanted cam driver driven by the water pressure driven turbine. Major components of the invention are part of claim 1, 2 and 3; miniature water turbine, clean-out system, speed controller valve.

5. In my invention of the Water Pressure Driven Wet and Dry Shaver with Beard Trimmer, and speed control page 4 of the drawing FIG. 9 and FIG. 10 shows the Water Pressure Driven Nose Hair Cutter, a vertical worm gear driven water turbine drives a straight, direct driven shaft connecting to an inverted U shaped blade (small enough to fit into the nostril) A, B, Off (three position) water valve in A position drives the hair cutter, in B position opens the valve to the rinsing nozzle to wash our any hair particles trough the rinsing outlet. Major components of the invention are part of claim 1, 2 and 3; miniature water turbine, clean-out system, speed controller valve.

6. In case of Flat Type of Shavers on FIG. 12, 13 and 14 my invention of the Water Pressure Driven Wet and Dry Shaver with Beard Trimmer, and speed control turbine is positioned sideways, parallel to the surface of the shaver where turbine rotation drives the attached cam and the cam follower oscillates the horizontal type shaver with single or multi blade assembly. The same cam assembly drives the pivotable side mounted beard cutting assembly.
Water cleaning nozzle is located below the oscillating blades. Hanging wall hook is attached to the apparatus for convenient shaver storage where the water can just drip out of the shaver.
Major components of the invention are part of claim 1, 2 and 3; miniature water turbine, clean-out system, speed controller valve.

7. In my invention of the Water Pressure Driven Wet and Dry Shaver with Beard Trimmer, Water Clean out and Speed Control is a true Wet and Dry shaver since it has no electric parts, uses no electricity, and it is safely functional in total dry condition or in wet area even while taking shower.
The unit is totally submergible, waterproof, hair trimming parts are stainless material. Major components of the invention are part of claim 1, 2 and 3; miniature water turbine, clean-out system, speed controller valve.

8. Since power derives from household City water pressure, my invention of the Water Pressure Driven Wet and Dry Shaver with Beard Trimmer, and speed control, it can be considered as a free “parasite”, reusable power source “parasite power source driven apparatus”
Depressurized water is clean, can be used for further household needs. Since water pressure is always present, it is ready to be used as soon as the diverter is activated, ready for immediate use.
No charging time is needed for shaving like for rechargeable battery operated electric shavers.
It is transplantable, portable, diverter is easily adaptable to most faucets Worldwide.
Major components of the invention are part of claim 1, 2 and 3; miniature water turbine, clean-out system, speed controller valve.

9. My invention of the Water Pressure Driven Wet and Dry Shaver with Beard Trimmer, and speed control with dependent claim is a Water Pressure Driven Wet and Dry Vibrating Massager.
Page 8 of the drawing FIG. 15 shows vertically positioned water turbine driven massager with detachable, interchangeable attachment where water can be injected into the tip of the massager with warm water.
Major components of the invention are part of claim 1, 2 and 3; miniature water turbine, clean-out system, speed controller valve.
